(19) United States
(12) Patent Application Publication
(10) Pub. No.: US 2014/0199211 A1
(43) Pub. Date: Jul. 17, 2014

(54) Combined Removal of Carbon Monoxide and Carbon Dioxide in a Refuge Chamber With a Single Air Circulation System

(71) Applicant: Monte Barrett Raber, Winnipeg (CA)

(72) Inventor: Monte Barrett Raber, Winnipeg (CA)

(21) Appl. No.: 14/106,418

(22) Filed: Dec. 13, 2013

Related U.S. Application Data
(60) Provisional application No. 61/848,889, filed on Jan. 15, 2013.

(51) Int. Cl. A62B 29/00

(52) U.S. Cl. CPC A62B 29/00
USPC 422/122

(57) ABSTRACT

A combination of an oxidizing catalyst entity to convert carbon monoxide and other oxidizable contaminants to carbon dioxide, followed by a carbon dioxide removing entity, both suitable for, and arranged within a single air system functioning at the ambient temperature and humidity of the space, to remove toxic oxidizable constituents and carbon dioxide to produce a cleaned breathable atmosphere in an enclosed space.

### CROSS-REFERENCE TO RELATED APPLICATIONS

This application is claiming the benefit of a Provisional Application: #61/848,889 Filing Date Jan. 15, 2013

### FIELD OF THE INVENTION

The present invention relates to an improved method and apparatus for cleaning the air of toxic gases within an enclosed space, like a mine refuge chamber, by combining the conversion of carbon monoxide, and other oxidizable contaminants in the air, to carbon dioxide, by a catalyst that functions at chamber ambient conditions, combined with the removal of carbon dioxide, in a single air circulation system.

### BACKGROUND TO THE INVENTION

### The Present State

In industries such as mining, refuge chambers are used to keep people alive in case of a catastrophic event. In some cases the people must remain in the chamber for days until rescue. The people in the chamber utilize oxygen and exhale carbon dioxide and water vapor, so the air in the space becomes very humid. The carbon dioxide accumulates and is toxic at a high concentration, so it must be removed. When the surrounding atmosphere contains carbon monoxide or other toxic gases some will be brought in as people enter, so those toxins must also be removed from the air in the chamber. The chemical reactions to clean the air must take place in the high humidity and ambient temperature of the chamber. FIG. 1 diagrammatically illustrates the two systems presently used to remove carbon monoxide and carbon dioxide from the chamber air. Two separate air systems are required because the reagents presently available can not be combined in a single system as they have opposite functional abilities in humid air.

The exhaled carbon dioxide is removed by a chemical absorber 5 (soda lime or lithium hydroxide). The carbon dioxide reacts with and is chemically held in the absorber material. The air is commonly circulated through the refuge by a blower 3, powered by an electrical or mechanical power supply 4. The absorber 5 may be in the form of a bed of granules, or attached to a sheet configuration. The reaction is mediated by moisture so it functions in the ambient air conditions of the chamber.

Carbon monoxide is removed from the air in a different manner, in a separate air system. The carbon monoxide is converted to carbon dioxide by an oxidizing catalyst 2. Hopcalite is commonly used as it is active at chamber ambient temperature, but it is inactivated by humidity. Therefore a drying material 1 is placed before the catalyst to dry the air. The drying material must be periodically replaced before it becomes saturated by the high humidity air. The produced carbon dioxide is added to the chamber air.

### DESCRIPTION OF PRIOR ART

With pre-existing catalytic materials, the removal of carbon monoxide cannot be combined with the removal of carbon dioxide because the catalytic entities that can function at ambient temperature require dry air and the carbon dioxide removing entity requires humid air. The circulated air in the chamber is therefore a combination of the two air streams—one with carbon dioxide added by the oxidation of carbon monoxide, and the other from the carbon dioxide removal process. Each air system, see FIG. 1, is made up of a reagent area, 1 and 2, or 5, a blower 3, and a power source 4—usually batteries. Even if some of the elements of the two systems may be combined, two air systems cost more and take more space than a single system—see FIG. 2. The following items are examples to illustrate the prior art that are related to this new invention.

The REFUGE ONE® unit manufactured by RANA Mine Refuge Systems is an example of a unit designed to supply oxygen and remove carbon dioxide from the air in a confined space. It consists of oxygen cylinders with pressure gauge and regulator, a container of soda-lime particles 5, a blower 3, batteries 4 and controls. The unit circulates the conditioned air through the space after processing by the carbon dioxide absorber. The soda-lime is to be replaced periodically on a schedule determined by the number of people in the space, since the material has a predetermined capacity for carbon dioxide.

Companies such as MineARC produce refuge chambers which incorporate air cleaning scrubbers similar to the previously described Refuge One® system, and also have a separate carbon monoxide scrubber system incorporating an oxidizing catalyst 2 preceded by a moisture removing material 1. The air intake of each system draws in air from the refuge chamber and circulates it back to the chamber after processing. Like the carbon dioxide absorbing reagent, the moisture removing material must be replaced periodically before it becomes saturated.

The MCASPA unit manufactured by Molecular Products is an example of a small, self-contained unit to remove carbon monoxide from air by conversion to carbon dioxide. It incorporates a drying material 1, a catalytic converter 2, blower 3, battery 4, and electronic controller. It is intended for approximately two hour operation before the drying entity becomes saturated with water and the effectiveness is reduced. Multiple units may be required depending on the size of the space and the initial concentration of carbon monoxide.

The principle of using reactive elements in series is not new, but for the application of removing carbon monoxide, there are few described. Kutta, U.S. Pat. No. 5,690,101 described a small, “elongated hollow body” , personal air purifier with a “carbon monoxide removal and fixation” zone followed by a carbon dioxide fixation layer and other reactive zones; to be used by an individual for a “predetermined short time period”. Unfortunately, he did not show or explain that the apparatus he described, using hopcalite, could only be used if the environment was dry air and the person did not exhale through the device, since humid inhaled and expired air would inactivate the hopcalite. The principles of that design, therefore, can not be applied to cleaning the air in a refuge chamber as it would not meet the environmental and operating time conditions.

### RELATED REFERENCES

U.S. Patent Documents

| | | |
|---|---|---|
| 4,536,375 | August 1985 | Holt, White |
| 7,246,621 B2 | July 2007 | McNeirney |
| 8,058,202 B2 | November 2011 | Brady, et al |
| 8,314,046 B2 | November 2012 | Brady, et al |
| 8,314,048 B2 | November 2012 | Brey, et al |
| 5,690,101 | November 1997 | Kutta |

### Other Publications:

MineARC Systems website: www.minearc.com Viewed, Dec. 23, 2012
Molecular Products website: molecularproducts.com Viewed, Dec. 23, 2012
RANA Mine Refuge Systems website: www.ranacaregroup.com Viewed Dec. 23, 2012

### DESCRIPTION OF THE INVENTION

At the present time, new types of gold nano-particle oxidizing catalysts are being produced—e.g. U.S. Pat. No. 8,058,202—that can function effectively in a humid air atmosphere at chamber ambient temperatures, and similar types of catalyst may be developed in the future. These new catalytic materials permit a new way of combining elements for removing unwanted oxidizable contaminants and carbon dioxide from the air in a single air circulation system as illustrated in FIG. 2.

This figure describes the invention of a combination of the new type of oxidizing catalytic entity 6, such as a gold nano-particle type, to convert carbon monoxide to carbon dioxide, followed by a carbon dioxide removal entity 5 in a single air system. This combination of entities is a more efficient and effective air cleaning system than using two separate systems. Such new catalysts will also oxidize other unwanted contaminants of the air (e.g. volatile organic contaminants) for removal by the following carbon dioxide removal element. Of course other reagent filters could also be placed in the air stream to remove other particular contaminants. In the combined system, the carbon dioxide produced by the conversion of the carbon monoxide is then removed and is not distributed into the refuge air space.

The combination, in a single air system, of the new type of oxidizing catalyst entity that can function in the chamber ambient conditions, installed ahead of the carbon dioxide removal entity in the air stream, is different from existing methods that require separate air systems. A single air cleaning process is an advantage because of the simplicity, reduced cost, space, and power required, compared to two separate air systems.

While the method of passing a fluid through successive different filtering or reactive entities is common, the combination of an oxidizing catalytic entity to produce carbon dioxide from unwanted oxidizable constituents in humid air at regular ambient temperature, followed by a carbon dioxide removal entity to remove the produced carbon dioxide, has not previously been implemented, because suitable reactive elements were not in existence. With the development of new oxidizing catalysts that do not require dry air, and can function at chamber ambient temperatures, this new combination of an oxidizing catalytic entity followed by a carbon dioxide removal entity can be implemented as a single air system.

### DESCRIPTION OF DRAWINGS

FIG. 1 Representation of The Present Method Using Two Separate Air Systems for Carbon Monoxide and Carbon Dioxide Removal.

This drawing illustrates the related components of two separate air circulation systems, one for conversion of carbon monoxide to carbon dioxide, the other for removal of carbon dioxide.

FIG. 2 Representation of this Invention—Representation of Single Air System for Combined Carbon Monoxide and Carbon Dioxide Removal.

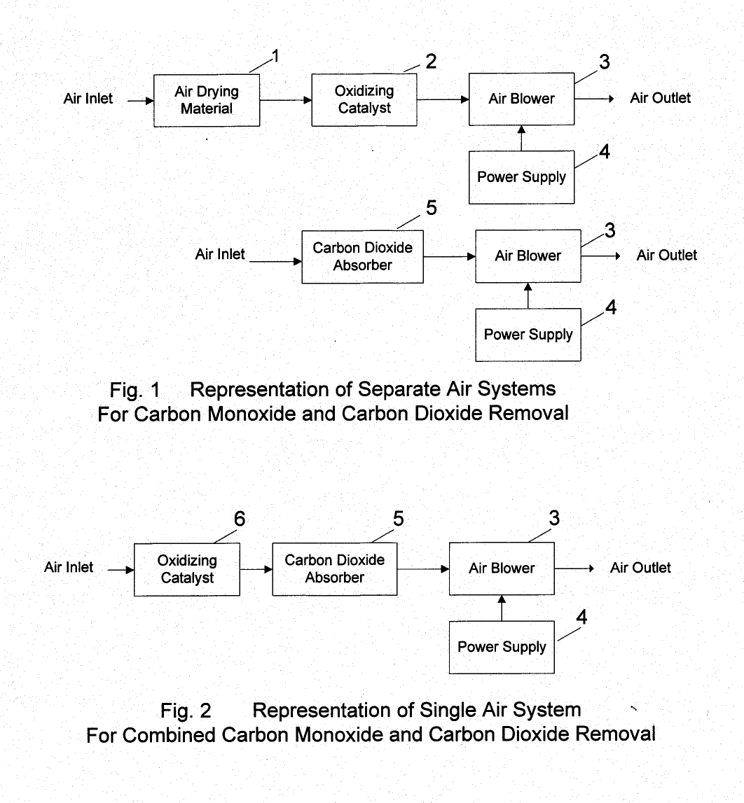

This drawing illustrates the related components of a Single Air System for Carbon Monoxide and Carbon Dioxide Removal. By comparison with FIG. 1, FIG. 2 illustrates the fewer components of a single air circulation system using the combination of entities described by this patent.

The entities related to this invention shown in the drawings are:
1. Air Drying Material entity
2. Existing type of Oxidizing Catalyst entity—requires dry air
3. Air Blower entity
4. Power Supply entity
5. Carbon Dioxide Absorber entity
6. New type of Oxidizing Catalyst entity that functions in chamber ambient conditions of humidity and temperature

### DESCRIPTION OF PREFERRED EMBODIMENTS

The combination of an oxidizing catalyst with a carbon dioxide absorber in a single system of this invention is diagrammatically illustrated in FIG. 2. The air is drawn in through the Oxidizing Catalyst entity 6, and then, containing carbon dioxide, flows through the Carbon Dioxide Absorber entity 5, and the cleaned air is blown out to the refuge chamber at the outlet of the Blower 3. Entities 2 and 5 are constructed so the air enters over a broad surface area so the air is spread out to provide a longer time in contact with the reactive materials, then the air is blown out at a high velocity so that it will circulate through the refuge chamber.

The size and volume of the containers of the reactive entities 6 and 5 must be designed to have sufficient volume and area of reactive material for the required reaction capacity, and to ensure that the ratio of area to depth produces a long enough residence time of the air in contact with the reactive material to ensure completion of the reaction for the materials that are selected. The oxidizing catalytic material must be one of the newer types that can function with humid air at chamber ambient temperature with a high effectiveness.

The chemical reagents may be used in a variety of different physical forms:
they may be collections of loose granules contained within filtered enclosures, or
they may be reactive particles deposited on the surface of relatively inert pellets that are formed into open-pored solid substrates, or
they may be reactive particles deposited on the surface of an inert carrier material formed into louvers, or a mesh, or honeycomb structure, or
a coil or sheets of sheet-like form, or
other physical form that allows the air to be blown through or along it, and come into contact with the large area reactive surface material.

The important factor is that the physical format of the system and the reagents permit the air stream to flow though the two reactive entities with minimal resistance, and stay in contact with the reactive chemical materials long-enough to react effectively.

This combination of a new type of carbon monoxide catalyst ahead of a carbon dioxide removal element may also be applied to other methods of providing breathing air. This combination may be used to safely ventilate closed and almost-closed work spaces located in environments contaminated with carbon monoxide and carbon dioxide, by bringing the contaminated air in through the combination of an oxidizing catalyst entity followed by a carbon dioxide removal entity—for example in a fixed or portable air cleaning system. Examples of such work spaces are tractor cabins and office space in a manufacturing facility, and temporary work enclosures.

I claim:

1. A combination of entities in a single air circulation system located within or external to a closed space, to catalytically oxidize toxic, such as carbon monoxide, or unwanted oxidizable contaminants, to carbon dioxide; followed by an entity to remove carbon dioxide from the air passing through the system, comprising:
a) an oxidizing catalyst entity, able to function in the temperature and humid ambient conditions of the closed space, to convert carbon monoxide and other oxidizable air contaminants to carbon dioxide, followed by;
b) a carbon dioxide removal entity; able to function in the temperature and humid ambient conditions of the closed space to remove carbon dioxide from the air.

2. The combination of entities of claim 1 where either of the chemically reactive materials may be in the form of collections of granules, where the granules may consist of the reagent materials in combination with inert materials, and the granules may be sized and shaped to permit air flow through the collection so that the air contacts the chemically reactive materials.

3. The combination of entities of claim 1 where either of the chemically reactive entities may be in the form of the reactive material applied to or embedded in the surface of a supporting material formed into granules or other form so the reactive material is exposed to the air stream.

4. The combination of entities of claim 3 where the material and form of the physically supporting material may be a lattice, or louvers, or mesh, or tubing, or other configuration to permit contact by the air with the surface of the reactive material that is applied to or embedded in the surface of the physically supporting material.

5. The combination of entities of claim 1 where the oxidizing catalyst is a type of gold nano catalyst.

6. The combination of entities of claim 1 used in a single air system of fixed or portable form arranged to supply cleaned air from a contaminated space to ventilate a closed or semi-closed work space located within the surrounding contaminated space, that uses the combination of elements comprising the catalytic oxidizing entity and the carbon dioxide absorbing entity described by claim 1, to clean the air.
